(19) United States
(12) Patent Application Publication
(10) Pub. No.: US 2008/0241329 A1
(43) Pub. Date: Oct. 2, 2008

(54) ANTIMICROBIAL COMPOSITION AND ITS USE IN READY-TO-DRINK BEVERAGES

(75) Inventors: Zuoxing Zheng, Palatine, IL (US); Charles Arthur Kennett, Brookfield, IL (US); Karl Ragnarsson, Chester, NY (US); Jeffrey Semanchek, Ramsey, NJ (US)

Correspondence Address: BROOKS KUSHMAN P.C., 1000 TOWN CENTER, TWENTY-SECOND FLOOR, SOUTHFIELD, MI, 48075, US

(73) Assignee: KRAFT FOODS HOLDINGS, INC., Northfield, IL (US)

(21) Appl. No.: 11/692,496

(22) Filed: Mar. 28, 2007

(51) Int. Cl. A23L 3/34

(52) U.S. Cl. 426/532

(57) ABSTRACT

An antimicrobial composition for food applications includes a chelating agent and a lauric acid derivative. The antimicrobial composition optionally includes one or more carboxylic acid derivatives. The chelating agent, the lauric acid derivative, and if present, one or more carboxylic acid derivatives are collectively present in an amount that is less that a taste threshold.

### BACKGROUND OF THE INVENTION

1. Field of the Invention

In at least one aspect, the present invention generally relates to antimicrobial compositions for use in food products.

2. Background Art

Spoilage resistance is desirable in all food products. In general, improvements in the spoilage characteristics of food products lead to retention of desirable color, flavor and nutrients with minimal formation of undesirable compounds. Economic benefits of reduced spoilage include cost reduction related to capital, energy and packaging material savings, and a longer shelf life.

Ready-to-drink (“RTD”) beverages are a class of food products in which spoilage reduction is desirable. Effective inhibition of all common spoilage organisms including vegetative gram positive and gram negative bacteria, bacterial spores, yeasts and molds in RTD beverages at ambient temperature is a challenge for the beverage industry. Currently, an effective ingredient solution for spoilage does not exist for cold fill juice-containing beverages. The most commonly used preservation method for such beverages is ultra high temperature treatment of the beverage and hot fill packaging. Both hot processing and hot filling of ready-to-drink beverages result in the loss of desirable flavor and color. Moreover, these processes typically require increased capital investment as well as additional operating and packaging material costs.

Cold fill processing of beverages is desirable as an alternative to the hot fill processes. However, cold fill processing of highly acidic, ready-to-drink beverages (especially juice-containing beverages) is often accompanied with a high risk of contamination by a variety of spoilage organisms—bacteria, yeasts and molds. To counter these undesirable microbes, preservatives are typically added to the beverages to extend shelf life. Currently, preservative solutions that prevent the growth of all these spoilage organisms in beverages at acceptable concentration levels do not exist. In these prior art preservative solutions, the amounts of preservatives are present at levels below the taste threshold or regulatory limits. At these levels, the preservative solutions are not sufficient to completely prevent the growth of the commonly present microbes in the constituent ingredients, the environment or the packaging materials.

Accordingly, there is a need for improved spoilage reducing compositions to be included in food products, and in particular, to be included in ready-to-drink beverages.

### SUMMARY OF THE INVENTION

The present invention solves one or more problems of the prior art by providing in at least one embodiment an antimicrobial composition for use in a food product. The antimicrobial composition of this embodiment includes a chelating agent and a lauric acid derivative. Advantageously, the chelating agent and the lauric acid derivative are collectively present in the antimicrobial composition in an amount that is less than a taste threshold. The antimicrobial composition optionally includes one or more carboxylic acid derivatives. When the antimicrobial cocktail of the present embodiment is incorporated into RTD beverages, the resulting product, in some variations, does not need to be heat-treated nor hot filled as is typically used to eliminate spoilage bacteria, molds, and yeasts. Therefore, the ability of the present invention to use cold process and/or cold fill is highly desirable by the beverage industry to circumvent the loss of flavor and color, and increase expense of the hot processes of the prior art.

In another embodiment of the present invention, an antimicrobial composition for use in a food product is provided. The composition of the present embodiment includes one or more carboxylic acid derivatives and a lauric acid derivative. Characteristically, the one or more carboxylic acid derivatives and the lauric acid derivative are collectively present in an amount that is less than a taste threshold. The antimicrobial composition optionally includes a chelating agent. As set forth above, when the antimicrobial cocktail of the present embodiment is incorporated into RTD beverages, the resulting product, in some variations, does not need to be heat treated nor hot filled as is typically used to eliminate spoilage bacteria, molds, and yeasts.

### DETAILED DESCRIPTION OF THE PREFERRED EMBODIMENT(S)

Reference will now be made in detail to presently preferred compositions, embodiments and methods of the present invention, which constitute the best modes of practicing the invention presently known to the inventors. The Figures are not necessarily to scale. However, it is to be understood that the disclosed embodiments are merely exemplary of the invention that may be embodied in various and alternative forms. Therefore, specific details disclosed herein are not to be interpreted as limiting, but merely as a representative basis for any aspect of the invention and/or as a representative basis for teaching one skilled in the art to variously employ the present invention.

Except in the examples, or where otherwise expressly indicated, all numerical quantities in this description indicating amounts of material or conditions of reaction and/or use are to be understood as modified by the word “about” in describing the broadest scope of the invention. Practice within the numerical limits stated is generally preferred. Also, unless expressly stated to the contrary: percent, “parts of,” and ratio values are by weight; the term “polymer” includes “oligomer,” “copolymer,” “terpolymer,” and the like; the description of a group or class of materials as suitable or preferred for a given purpose in connection with the invention implies that mixtures of any two or more of the members of the group or class are equally suitable or preferred; description of constituents in chemical terms refers to the constituents at the time of addition to any combination specified in the description, and does not necessarily preclude chemical interactions among the constituents of a mixture once mixed; the first definition of an acronym or other abbreviation applies to all subsequent uses herein of the same abbreviation and applies mutatis mutandis to normal grammatical variations of the initially defined abbreviation; and, unless expressly stated to the contrary, measurement of a property is determined by the same technique as previously or later referenced for the same property.

It is also to be understood that this invention is not limited to the specific embodiments and methods described below, as specific components and/or conditions may, of course, vary. Furthermore, the terminology used herein is used only for the purpose of describing particular embodiments of the present invention and is not intended to be limiting in any way.

It must also be noted that, as used in the specification and the appended claims, the singular form “a”, “an”, and “the” can also comprise plural referents unless the context clearly indicates otherwise. For example, reference to a component in the singular is intended to comprise one or more of the components.

Throughout this application, where publications are referenced, the disclosures of these publications in their entireties are hereby incorporated by reference into this application to more fully describe the state of the art to which this invention pertains.

In an embodiment of the present invention, an antimicrobial composition for use in a food product is provided. The antimicrobial composition of this embodiment includes a chelating agent and a lauric acid derivative. Advantageously, in a variation of the present embodiment, the chelating agent and the lauric acid derivative are collectively present in an amount that is less than a taste threshold. In a variation of the present embodiment, the antimicrobial composition further comprises one or more carboxylic acid derivatives. The antimicrobial compositions of the present embodiment inhibit the growth of a wide range of cold processes and cold fill related spoilage organisms in beverages. Accordingly, in at least some variations of the present embodiment, the antimicrobial compositions enable the utilization of cold processing and/or cold fill for many ready-to-drink beverages including juice-containing drinks. Moreover, the antimicrobial composition of the present embodiment is to effectively inhibit the growth of spoilage organisms in juice-containing drinks.

In one refinement of the present embodiment, the chelating agent, the lauric acid derivative, and when present, the one or more carboxylic acid derivatives are collectively present in the antimicrobial composition in an amount that is less than about 5000 ppm. In another variation, the chelating agent, the lauric acid derivative, and when present, the one or more carboxylic acid derivatives are collectively present in the antimicrobial composition in an amount that is less than about 4500 ppm. In another variation, the chelating agent, the lauric acid derivative, and when present, the one or more carboxylic acid derivatives are collectively present in the antimicrobial composition in an amount that is less than about 4000 ppm. In another variation, the chelating agent, the lauric acid derivative, and when present, the one or more carboxylic acid derivatives are collectively present in the antimicrobial composition in an amount that is greater than about 4 ppm. In yet another variation, the chelating agent, the lauric acid derivative, and when present, the one or more carboxylic acid derivatives are collectively present in the antimicrobial composition in an amount from 4 ppm to 5000 ppm.

The antimicrobial composition of the present embodiment includes a lauric acid derivative. While any suitable lauric acid derivative may be used, a particularly useful lauric acid derivative comprises ethyl-N-dodecanoyl-L-arginate or derivatives thereof. In a refinement, the ethyl-N-dodecanoyl-L-arginate is present in the antimicrobial composition in an amount from about 1 ppm to 1000 ppm. In a refinement of the present embodiment, the ethyl-N-dodecanoyl-L-arginate is present in the antimicrobial composition in an amount from about 5 ppm to 500 ppm. In a further refinement of the present embodiment, the ethyl-N-dodecanoyl-L-arginate is present in the antimicrobial composition in an amount from about 10 ppm to 100 ppm. In still a further refinement of the present embodiment, the ethyl-N-dodecanoyl-L-arginate is present in the antimicrobial composition in an amount from about 5 ppm to 30 ppm. The taste threshold of lauric arginate is determined to be about 30 ppm, and this concentration is used in all of the inventive examples. Lauric arginate at concentrations below taste threshold is a useful component of the antimicrobial system of various embodiments of the invention. If its concentration increases, the concentrations of other components may be reduced but the negative flavor impact on the beverages would become unacceptable.

The antimicrobial composition of the present embodiment includes a chelating agent. While any suitable chelating agent can be used, a particularly useful chelating agent comprises ethylenediaminetetraacetic acid or derivatives thereof. In a refinement of the present embodiment, the chelating agent is present in an amount from about 1 ppm to 300 ppm. In a further refinement of the present embodiment, the chelating agent is present in an amount from about 1 ppm to 100 ppm. In yet a further refinement of the present embodiment, the chelating agent is present in an amount from about 10 ppm to 30 ppm.

As set forth above, the antimicrobial composition optionally includes one or more carboxylic acid derivatives. Virtually, any carboxylic acid derivative compatible with human consumption may be used. Carboxylic acid salts are particularly useful. In such salts, common counter ions include potassium and sodium. Examples of useful carboxylic acid derivatives include, but are not limited to, sorbates, benzoates, and combinations thereof. In a particularly useful variation, the one or more carboxylic acid derivatives comprise a sorbate and a benzoate. Specific examples of sorbates include potassium sorbate and sodium sorbate. Similarly, specific examples of benzoates include potassium benzoate and sodium benzoate. In one refinement of the present embodiment, the one or more carboxylic acid derivatives are present in an amount from about 1 ppm to 3000 ppm. In a further refinement of the present embodiment, the one or more carboxylic acid derivatives comprise sorbate present in an amount from about 1 ppm to 2000 ppm and benzoate present in an amount from about 1 ppm to 1000 ppm.

In another embodiment of the present invention, another antimicrobial composition for use in a food product is provided. The composition of the present embodiment includes one or more carboxylic acid derivatives and a lauric acid derivative. In variations of the present embodiment, the antimicrobial composition further includes a chelating agent. The amounts and specific examples of the components of the present embodiment are the same as those set forth above.

In still another embodiment of the present invention, another antimicrobial composition for use in a food product is provided. The antimicrobial composition of the present embodiment includes a sorbate, a benzoate, ethylenediaminetetraacetic acid, and ethyl-N-dodecanoyl-L-arginate or a derivative of ethyl-N-dodecanoyl-L-arginate. The sorbate, the benzoate, the chelating agent, and the ethyl-N-dodecanoyl-L-arginate or derivative thereof are collectively present in an amount less than 5000 ppm. The amounts and specific examples of the components of the present embodiment are the same as those set forth above.

In a variation of the present embodiment, the sorbate, the benzoate, the chelating agent, and the ethyl-N-dodecanoyl-L-arginate or derivative thereof are collectively present in an amount greater than 4 ppm. In a refinement of the present embodiment, one or more of the following conditions are satisfied: the sorbate is present in an amount from about 1 ppm to 2000 ppm; the benzoate present in an amount from about 1 ppm to 1000 ppm; the ethylenediaminetetraacetic acid is present in an amount from about 1 ppm to 300 ppm; and the ethyl-N-dodecanoyl-L-arginate is present in an amount from about 1 ppm to 1000 ppm.

In the refinement of the present embodiment, one or more of the following conditions are satisfied: the sorbate is present in an amount from about 50 ppm to 500 ppm; the benzoate present in an amount from about 50 ppm to 500 ppm; ethylenediaminetetraacetic acid is present in an amount from about 1 ppm to 300 ppm; and the ethyl-N-dodecanoyl-L-arginate is present in an amount from about 1 ppm to 1000 ppm.

In another embodiment of the present invention, a beverage including the antimicrobial compositions set forth above are provided. The beverage of this embodiment includes a food component and the antimicrobial compositions. Moreover, the beverages used herein can be cold processed or cold filled RTD beverages. In one refinement, the beverage compositions of this embodiment include a juice-containing component and the antimicrobial composition.

In yet another embodiment of the present invention, a method of forming a microbial resistant beverage is provided. The microbial resistant beverage of this embodiment is formed by adding the antimicrobial compositions set forth above to a base beverage composition. In the present context, “base beverage composition” means any ready-to-drink beverage composition not containing the antimicrobial compositions of the embodiment of the present invention. In a specific variation, the antimicrobial composition comprises a lauric acid derivative and an additional component or components selected from the group consisting of a chelating agent, one or more carboxylic acid derivatives, and combinations thereof. In this variation, the lauric acid derivative and the additional component or components are collectively present in the antimicrobial composition in an amount that is less than 5000 ppm. In a refinement of the present embodiment, one or more of the components of the antimicrobial compositions are combined together before being added to a base beverage composition. In another refinement of the present embodiment, each component of the antimicrobial composition is independently added to a base beverage composition. Advantageously, the antimicrobial compositions of the present invention are sufficiently effective to allow the elimination of heat processing during beverage production thereby allowing cold process and cold fill. Of course, if desired, hot processing of beverage formed in the present embodiment may also be utilized.

The following examples illustrate the various embodiments of the present invention. Those skilled in the art will recognize many variations that are within the spirit of the present invention and scope of the claims.

The examples set forth herein demonstrate the effective prevention of a variety of spoilage issues caused by bacteria, yeast and mold, with a combination of lauric arginate and traditional preservatives at concentrations below acceptable taste thresholds. In these examples, a number of different combinations that include a cationic compound—lauric arginate (N-a-Lauroyl-L-arginine ethyl ester monohydrochloride (“LAE”) and the preservatives—potassium sorbate, sodium benzoate and EDTA are investigated against a number of selected spoilage bacteria, yeasts and molds commonly found in ready-to-drink beverages. The selected organisms used in microbial challenge studies and their preparation method, inoculation level, challenge conditions as well as the criteria for pass or fail are listed in Table 1. The selected organisms are a collection of actual microorganisms that previously had spoiled beverages. However, not all organisms are used in every situation. Some organisms are used for juice containing vs. non-juice containing products or for processes utilizing a heat step vs. cold process/cold fill products. Similarly, inoculum level is also influenced by use of raw materials (e.g. presence of juice) and utilization of heat in the process.

TABLE 1
Spoilage organisms used in microbiological challenge studies

| | | | | | | |
|---|---|---|---|---|---|---|
| | Cultivation | Times of | Storage of | Inoculum | Storage | Pass/Fail |
| Organism | medium | transfer | inoculum | level | temp. | criteria |

BACTERIA

| | | | | | | |
|---|---|---|---|---|---|---|
| Alicyclobacillus | OSA agar, | 1–2 | Sterile | Low–High | 25–30° C. | No growth; |
| acidoterrestris | 3–5 days at | | Phosphate | 10¹–10⁴ cfu/ml | | no off odor/ |
| (VF strain) | 45 C | | buffer at 4° C. | | | off flavor |
| Alicyclobacillus | OSA agar, | 1–2 | Sterile | Low–High | 25–30° C. | No growth; |
| acidoterrestris | 3–5 days at | | Phosphate | 10¹–10⁴ cfu/ml | | no off odor/ |
| (Sport strain) | 45 C | | buffer at 4° C. | | | off flavor |
| Gluconobacter | Acidified | 1–2 | Sterile | Low–High | 25–30° C. | No growth; |
| oxydans | (pH 3.5) | | Phosphate | 10¹–10⁴ cfu/ml | | no off odor/ |
| | MEA, 3–5 | | buffer at 4° C. | | | off flavor |
| | days, at 25 C | | | | | |
| Gluconoacetobacter | Acidified | 1–2 | Sterile | Low–High | 25–30° C. | No growth; |
| liquifaciens | (pH 3.5) | | Phosphate | 10¹–10⁴ cfu/ml | | no off odor/ |
| | MEA, 3–5 | | buffer at 4° C. | | | off flavor |
| | days, at 25 C | | | | | |
| Gluconoacetobacter | Acidified | 1–2 | Sterile | Low–High | 25–30° C. | No growth; |
| diazotrophicus | (pH 3.5) | | Phosphate | 10¹–10⁴ cfu/ml | | no off odor/ |
| | MEA, 3–5 | | buffer at 4° C. | | | off flavor |
| | days, at 25 C | | | | | |
| Acetobacter | Acidified | 1–2 | Sterile | Low–High | 25–30° C. | No growth; |
| tropicalis | (pH 3.5) | | Phosphate | 10¹–10⁴ cfu/ml | | no off odor/ |
| | MEA, 3–5 | | buffer at 4° C. | | | off flavor |
| | days, at 25 C | | | | | |
| Acetobacter | Acidified | 1–2 | Sterile | Low–High | 25–30° C. | No growth; |
| calcoaceticus | (pH 3.5) | | Phosphate | 10¹–10⁴ cfu/ml | | no off odor/ |
| | MEA, 3–5 | | buffer at 4° C. | | | off flavor |
| | days, at 25 C | | | | | |
| YEAST | | | | | | |
| Candida | Acidified | 1–2 | Sterile | Low–High | 25–30° C. | No growth; |
| lypolytica | (pH 3.5) | | Phosphate | 10¹–10⁴ cfu/ml | | no off odor/ |
| | PDA, 3–5 | | buffer at 4° C. | | | off flavor |
| | days, at 25 C | | | | | |
| Saccharomyces | Acidified | 1–2 | Sterile | Low–High | 25–30° C. | No growth; |
| cerevisiae | (pH 3.5) | | Phosphate | 10¹–10⁴ cfu/ml | | no off odor/ |
| | PDA, 3–5 | | buffer at 4° C. | | | off flavor |
| | days, at 25 C | | | | | |
| MOLD | | | | | | |
| Aspergillus | Acidified | 1–2 | Sterile | Low–High | 25–30° C. | No growth; |
| niger | (pH 3.5) | | Phosphate | 10¹–10⁴ cfu/ml | | no off odor/ |
| | PDA, 3–5 | | buffer at 4° C. | | | off flavor |
| | days, at 25 C | | | | | |
| Penicillium | Acidified | 1–2 | Sterile | Low–High | 25–30° C. | No growth; |
| spinulosum | (pH 3.5) | | Phosphate | 10¹–10⁴ cfu/ml | | no off odor/ |
| | PDA, 3–5 | | buffer at 4° C. | | | off flavor |
| | days, at 25 C | | | | | |

Unless otherwise indicated, all results of challenge studies are reported as Pass or Fail as described in Table 1. For microbial growth, in general, no detectable live cells present or less than 1 log of cell increase is considered as no growth while more than 1 log of cell increase is considered as a positive growth. “Pass” means there is not any growth of all challenged organisms during the course of study as described in Table 1 while “Fail” means there is positive growth of at least one of the challenged organisms during the course of the study.

### EXAMPLE 1

### A Fruit Juice-Containing RTD Beverage

A commercial fruit punch beverage is purchased from a local grocery store. It contained 10% mixed fruit juices with a pH of 3.5 and no preservatives. The main ingredients in the beverage included water, high fructose corn syrup, pear and grape juice concentrates, citric acid, water extracted orange and pineapple juice concentrates and natural flavors. This product represents a group of fruit punch and juice blended ready-to-drink beverages. The original beverage is used as control, and samples with added antimicrobials in a number of combinations are used as treatments. The spoilage bacteria, yeast and mold cocktails listed in Table 1 are used in this challenge study. The results of microbial challenge study are summarized in Table 2.

TABLE 2
Microbial challenge study for the fruit punch beverage

| | Lauric | | Na- | | |
|---|---|---|---|---|---|
| Treatment | Arginate | K-sorbate | benzoate | EDTA | Result |
| Test 1 | 0 | 0 | 0 | 0 | Fail (<8 days) |
| Test 2 | 30 ppm | 0 | 0 | 0 | Fail (<8 days) |
| Test 3 | 50 ppm | 0 | 0 | 0 | Fail (<7 days) |
| Test 4 | 100 ppm | 0 | 0 | 0 | Fail (<9 days) |
| Test 5 | 0 | 300 ppm | 300 ppm | 30 ppm | Fail (<13 days) |
| Test 6 | 30 ppm | 300 ppm | 0 | 0 | Fail (<8 days) |
| Test 7 | 30 ppm | 200 ppm | 200 ppm | 30 | Fail (<9 days) |
| Inventive | 30 ppm | 300 ppm | 300 ppm | 30 ppm | Pass |
| | | | | | (>8 months) |

These results suggest that among all tested variables, only the inventive composition (combination of lauric arginate, sorbate, benzoate and EDTA) passed the comprehensive microbial challenge study in a juice-containing RTD beverage.

### EXAMPLE 2

### A Fruit Punch Flavored Sport Drink

A fruit punch flavored sport drink is purchased from a local grocery store. This beverage contains fruit flavors while having 0% fruit juices and preservatives. The pH of this beverage is 3.5. The main ingredients in this beverage includes water, high fructose corn syrup, sugar, citric acid, sodium citrate, potassium citrate and natural flavors. This product represents a group of fruit punch flavored ready-to-drink sport drinks. The original beverage is used as control, and samples with added antimicrobials in a number of combinations are used as treatments. The spoilage bacteria, yeast and mold cocktails listed in Table 1 are used in this challenge study. The results of microbial challenge study are summarized in Table 3.

TABLE 3
Microbial challenge study for the fruit punch flavored sport drink

| | Lauric | | Na- | | |
|---|---|---|---|---|---|
| Treatment | Arginate | K-sorbate | benzoate | EDTA | Result |
| Test 1 | 0 | 0 | 0 | 0 | Fail (<8 days) |
| Test 2 | 30 ppm | 0 | 0 | 0 | Fail (<8 days) |
| Test 3 | 50 ppm | 0 | 0 | 0 | Fail (<7 days) |
| Test 4 | 0 | 300 ppm | 300 ppm | 30 ppm | Fail (<13 days) |
| Test 5 | 30 ppm | 300 ppm | 0 | 0 | Fail (<8 days) |
| Test 6 | 30 ppm | 200 ppm | 200 ppm | 30 | Fail (<1 month) |
| Inventive | 30 ppm | 300 ppm | 300 ppm | 30 ppm | Pass |
| | | | | | (>8 months) |

These results obtained in a non-juice containing RTD beverage are similar to those obtained in a juice-containing beverage, and the inventive composition (combination of lauric arginate, sorbate, benzoate and EDTA) passed the comprehensive microbial challenge study.

### EXAMPLE 3

### A Nutrient Fortified Spring Water

A nutrient fortified spring water beverage is purchased from a local grocery store. This beverage contains essential vitamins and minerals for health benefits along with 0% fruit juices and 0% calories and sugar. This beverage has a pH of 3.1. The main ingredients in this beverage include spring water, natural flavors, citric acid, malic acid, sucralose (sweetener) and healthy nutrients such as vitamin C, vitamin E, niacin, vitamin B6, vitamin B12, biotin, pantothenic acid, magnesium, zinc and selenium. This product represents a group of zero-calories, sugar-free, nutrients-fortified flavored spring water beverages. The original beverage is used as control, while samples with added antimicrobials in a number of combinations are used as treatments. The spoilage microorganisms used in the challenge study include yeast and mold cocktails and Gluconoacetobacter species. The results of microbial challenge study are summarized in Table 4.

TABLE 4
Microbial challenge study for a nutrient fortified spring water beverage

| | Lauric | | | | | |
|---|---|---|---|---|---|---|
| Treatment | Arginate | K-sorbate | Na-benzoate | EDTA | Natamycin | Result |
| Test 1 | 0 | 175 ppm | 175 ppm | 0 | 0 | Fail (<7 days) |
| Test 2 | 30 ppm | 175 ppm | 175 ppm | 0 | 0 | Fail (<33 days) |
| Test 3 | 0 | 175 ppm | 175 ppm | 30 ppm | 0 | Fail (<7 days) |
| Test 4 | 0 | 175 ppm | 175 ppm | 0 | 10 ppm | Fail (<33 days) |
| Inventive | 30 ppm | 175 ppm | 175 ppm | 30 ppm | 0 | Pass |
| | | | | | | (>4 months) |

Again, in this example, the inventive composition (combination of lauric arginate, sorbate, benzoate and EDTA) is the only antimicrobial system that passed the comprehensive microbial challenge study in a nutrient fortified spring water beverage.

### EXAMPLE 4

### Cold-Filled Juice-Containing RTD Beverage

A base formula for an artificially flavored juice-containing RTD beverage is used in this example. This RTD beverage contains 10% apple juice, vitamin C, natural and artificial flavors, citric acid, sucrose and acesulfame potassium as sweeteners, and blue 1 as colorant. The pH of this beverage is 3.3. Three different antimicrobial ingredient combinations are formulated into the base formula. Each formulation is either processed without any heating and filled at 70° F., known as “cold process, cold fill” (labeled as “cold/cold” in Table 5) or pasteurized at 243° F. for 3 seconds and then cooled down to 70° F. and filled, known as “hot process, cold fill” (labeled as “hot/cold” in Table 5). The details of each antimicrobial formula and process conditions are listed in Table 5.

TABLE 5
Antimicrobial formulas and process conditions for an artificially flavored
juice drink and their microbial stability

| Production | Lauric | K- | | | Process/Fill | |
|---|---|---|---|---|---|---|
| batch | Arginate | Sorbate | Na-Benzoate | EDTA | Condition | Result |
| A | 0 ppm | 300 ppm | 300 ppm | 30 ppm | Cold/Cold | Fail (<1 month) |
| B | 0 ppm | 300 ppm | 300 ppm | 30 ppm | Hot/Cold | Fail (<1 month) |
| C | 30 ppm | 300 ppm | 300 ppm | 30 ppm | Cold/Cold | Pass (>4 months) |
| D | 30 ppm | 300 ppm | 300 ppm | 30 ppm | Hot/Cold | Pass (>4 months) |
| E | 30 ppm | 450 ppm | 150 ppm | 30 ppm | Cold/Cold | Pass (>4 months) |
| F | 30 ppm | 450 ppm | 150 ppm | 30 ppm | Hot/Cold | Pass (>4 months) |

All beverage samples are inoculated with common spoilage bacterial, yeast and mold cocktails as described in Table 1. The samples are stored at an ambient temperature for microbial growth test. The results of microbial challenge study are summarized in Table 5.

Following storage for four weeks at ambient temperature samples A and B (without lauric arginate) fail due to yeast growth and fermentation.

The samples containing variations of the antimicrobial compositions of the present invention (combinations of lauric arginate, sorbate, benzoate and EDTA) in batches C, D, E and F fail to show any substantial presence of bacteria, yeast and mold after 12 weeks of storage. Accordingly, these samples are considered as passing the comprehensive microbial challenge study.

These results suggest that the antimicrobial compositions of the present invention are sufficiently effective to allow the elimination of heat processing during beverage production thereby allowing cold process and cold fill. Heretofore, this type of processing has not been successful. The substitution of the widely employed hot process/hot fill processing with cold process/cold fill processing in the RTD beverage industry will provide dramatic quality and economic benefits.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. An antimicrobial composition for use in a food product, the composition comprising:
a chelating agent; and
a lauric acid derivative wherein the chelating agent and the lauric acid derivative are collectively present in the antimicrobial composition in an amount that is less than 5000 ppm.

2. An antimicrobial composition further comprising one or more carboxylic acid derivatives.

3. The antimicrobial composition of claim 2 wherein the one or more carboxylic acid derivatives, the chelating agent, and the lauric acid derivative are collectively present in the antimicrobial composition in an amount from 4 ppm to 5000 ppm.

4. The antimicrobial composition of claim 2 wherein the one or more carboxylic acid derivatives are selected from the group consisting of sorbates, benzoates, and combinations thereof.

5. The antimicrobial composition of claim 2 wherein the one or more carboxylic acid derivatives comprise a sorbate and a benzoate.

6. The antimicrobial composition of claim 2 wherein the one or more carboxylic acid derivatives are present in the antimicrobial composition in an amount from about 1 ppm to 3000 ppm.

7. The antimicrobial composition of claim 2 wherein the one or more carboxylic acid derivatives comprise sorbate present in the antimicrobial composition in an amount from about 1 ppm to 2000 ppm and benzoate present in the antimicrobial composition in an amount from about 1 ppm to 1000 ppm.

8. The antimicrobial composition of claim 1 wherein the lauric acid derivative comprises ethyl-N-dodecanoyl-L-arginate or derivatives thereof.

9. The antimicrobial composition of claim 8 wherein the ethyl-N-dodecanoyl-L-arginate is present in the antimicrobial composition in an amount from about 1 ppm to 1000 ppm.

10. The antimicrobial composition of claim 8 wherein the ethyl-N-dodecanoyl-L-arginate is present in the antimicrobial composition in an amount from about 5 ppm to 500 ppm.

11. The antimicrobial composition of claim 8 wherein the ethyl-N-dodecanoyl-L-arginate is present in the antimicrobial composition in an amount from about 10 ppm to 100 ppm.

12. The antimicrobial composition of claim 1 wherein the chelating agent comprises ethylenediaminetetraacetic acid or derivatives thereof.

13. The antimicrobial composition of claim 1 wherein the chelating agent is present in the antimicrobial composition in an amount from about 1 ppm to 300 ppm.

14. The antimicrobial composition of claim 1 wherein the chelating agent is present in the antimicrobial composition in an amount from about 1 ppm to 100 ppm.

15. The antimicrobial composition of claim 1 wherein the chelating agent is present in the antimicrobial composition in an amount from about 10 ppm to 30 ppm.

16. An antimicrobial composition for use in a food product, the composition comprising:
one or more carboxylic acid derivatives; and
a lauric acid derivative wherein the one or more carboxylic acid derivatives, the chelating agent, and the lauric acid derivative are collectively present in the antimicrobial composition in an amount that is less than 5000 ppm.

17. The antimicrobial composition of claim 1 further comprising a chelating agent.

18. An antimicrobial composition for use in a food product, the composition comprising:
a sorbate;
a benzoate;
ethylenediaminetetraacetic acid; and
ethyl-N-dodecanoyl-L-arginate or a derivative thereof, wherein the sorbate, the benzoate, the chelating agent, and the ethyl-N-dodecanoyl-L-arginate or derivative thereof are collectively present in the antimicrobial composition in an amount less than 5000 ppm.

19. The antimicrobial composition of claim 18 wherein the sorbate, the benzoate, the chelating agent, and the ethyl-N-dodecanoyl-L-arginate or derivative thereof are collectively present in the antimicrobial composition in an amount greater than 4 ppm.

20. The antimicrobial composition of claim 18 wherein:
the sorbate is present in the antimicrobial composition in an amount from about 1 ppm to 2000 ppm;
the benzoate present in the antimicrobial composition in an amount from about 1 ppm to 1000 ppm;
ethylenediaminetetraacetic acid is present in the antimicrobial composition in an amount from about 1 ppm to 300 ppm; and
the ethyl-N-dodecanoyl-L-arginate is present in the antimicrobial composition in an amount from about 1 ppm to 1000 ppm.

21. The antimicrobial composition of claim 18 wherein:
the sorbate is present in the antimicrobial composition in an amount from about 50 ppm to 500 ppm;
the benzoate present in the antimicrobial composition in an amount from about 50 ppm to 500 ppm;
ethylenediaminetetraacetic acid is present in the antimicrobial composition in an amount from about 1 ppm to 300 ppm; and
the ethyl-N-dodecanoyl-L-arginate is present in the antimicrobial composition in an amount from about 1 ppm to 1000 ppm.

22. The antimicrobial composition of claim 18 wherein the ethyl-N-dodecanoyl-L-arginate is present in the antimicrobial composition in an amount from about 5 ppm to 500 ppm.

23. The antimicrobial composition of claim 18 wherein the ethylenediaminetetraacetic acid is present in the antimicrobial composition in an amount from about 1 ppm to 100 ppm.

24. The antimicrobial composition of claim 18 wherein the ethylenediaminetetraacetic acid is present in the antimicrobial composition in an amount from about 10 ppm to 30 ppm.

25. A method of forming a microbial-resistant beverage, the method comprising:
combining an antimicrobial composition with a base beverage composition, the antimicrobial composition comprising:
a lauric acid derivative;
an additional component or components selected from the group consisting of a chelating agent, one or more carboxylic acid derivatives, and combinations thereof,
wherein the lauric acid derivative and the additional component or components are collectively present in the antimicrobial composition in an amount that is less than 5000 ppm.
